(19) United States
(12) Patent Application Publication
(10) Pub. No.: US 2011/0135899 A1
(43) Pub. Date: Jun. 9, 2011

(54) Films And Articles Made With Thermoplastic Block Copolymers

(75) Inventors: Donald A. Meltzer, Akron, OH (US); Robert J. Wiessner, Bladel (NL); Julius Farkas, North Ridgeville, OH (US)

(73) Assignee: LUBRIZOL ADVANCED MATERIALS, INC., Cleveland, OH (US)

(21) Appl. No.: 13/057,321

(22) PCT Filed: Jul. 30, 2009
(86) PCT No.: PCT/US09/52178

§ 371 Date: Feb. 3, 2011

(30) Foreign Application Priority Data
Aug. 6, 2008 (US) 61086571

(51) Int. Cl. B32B 27/40; B32B 5/02; B32B 27/04; D06N 3/14; B32B 7/02; B05D 1/36; B05D 3/02

(52) U.S. Cl. 428/217; 442/62; 428/423.1; 428/423.3; 428/425.8; 428/221; 427/407.1; 427/373

(57) ABSTRACT

The present invention relates to printing blankets, pipe liners, conveyor belts, inflatable articles, collapsible containers, protective clothing, and other types of coated fabrics that are manufactured with a thermoplastic block copolymer (TBC). This TBC can be a thermoplastic polyurethane (TPU), a copolyester (COPE), a copolyamide (COPA) or a polyurethaneurea (TPUU). The subject invention more specifically discloses a printing blanket or printing sleeve and a cured in place liner for a passageway or pipe. The TBC is (I) the reaction product of (1) a hydrophobic polyol or polyamine, (2) a polyisocyanate or an aromatic dicarboxylic acid, and (3) a linear chain extender containing 2 to 20 carbon atoms, or (II) the reaction product of (1) a hydrophobic polyol or polyamine, and (2) a carboxylic terminated telechelic polyamide sequence.

### FIELD OF THE INVENTION

The present invention relates to printing blankets, pipe liners, and coated fabrics that are manufactured utilizing a soft, hydrophobic thermoplastic block copolymer (TBC) having a melting point which is within the range of about 80° C. to about 250° C. and which is preferable within the range of about 80° C. to about 175° C. This TBC offers a unique array of characteristics that are highly desirable for utilization in manufacturing products of these types.

### BACKGROUND OF THE INVENTION

TPU (thermoplastic polyurethane) polymers are typically made by reacting (1) a hydroxyl terminated polyether or hydroxyl terminated polyester, (2) a chain extender, and (3) an isocyanate compound. Various types of compounds for each of the three reactants are disclosed in the literature. The TPU polymers made from these three reactants find use in various fields where products are made by melt processing the TPU and tbrming it into various shapes to produce desired articles by processes such as extrusion and molding. Important uses for TPU include manufacturing shoe soles, hoses, cable jacketing, coated fabrics such as conveyor belts, sewer liners and printing blankets, protective coatings, adhesives, and melt spun elastic fibers.

TPUs are segmented polymers having soft segments and hard segments. This feature accounts for their excellent elastic properties. The soft segments are derived from the hydroxyl terminated polyether or polyester and the hard segments are derived from the isocyanate and the chain extender. The chain extender is typically one of a variety of glycols, such as ,4-butane glycol.

U.S. Pat. No. 5,959,059 discloses a TPU made from a hydroxyl terminated polyether, a glycol chain extender, and a diisocyanate. This TPU is described as being useful for making fibers, golf ball cores, recreational wheels, and other uses.

In numerous applications, it would be desirable for the TBC to exhibit high tensile strength and a high elongation at break coupled with a melting point of less than about 175° C. In many of these applications, it would also be desirable for the TBC to be hydrophobic, to be thermally or oxidatively stable, to be capable of being swollen by oil, such as mineral oils, and to exhibit low tensile set.

### SUMMARY OF THE INVENTION

The soft, hydrophobic thermoplastic block copolymer (TBC) utilized in the practice of this invention offers a unique array of chemical and physical characteristics that makes it highly desirable for use in manufacturing printing blankets, pipe liners, conveyor belts (for food handling, airport baggage handling, pharmaceutical product handling, and the like), inflatable products (including air mattresses, boats, escape slides, floating devices, life rafts, lifting devices, oil booms, safety platforms, and weather balloons), collapsible containers (for vegetable oils, fuels, lubricating oils, heating oils, hydraulic fluids, industrial sewage, water, wine, and other beverages), protective cloth (for body bags, tents, equipment covers, seam sealing cloth, surgical drapes, and wet suits) and a variety of coated fabric products, including automotive interior trim, decorative cloth, grape press membranes, hot air balloons, labels and stickers, respiration devices, and seals.

The TBCs used in accordance with this invention is semicrystalline and can be a polyurethane (TPU), a copolyester (COPE), a copolyamides (COPA), or a polyurethaneurea (TPUU). TBCs utilized in the practice of this invention exhibit a high tensile strength, a high elongation at break, a melting point of less than about 250° C. and a glass transition temperature of less than about 0° C. The TBC employed in the practice of this invention is also hydrophobic, has a density of less than 1.1, and offers low tensile set. In some cases, it is preferable for the TBC employed in the practice of this invention to have a density of less than 1.0 or even less than 0.95. For instance, it is important for the TBC to be of a low density in applications where it is used in manufacturing coated fabrics for hot air balloons, ultra-light aircraft wings, and floatation devices, such as safety vests for aircraft and watercraft. The TBC is also good for use in such applications because it is hydrophobic in nature and can withstand continuous use at elevated temperatures or at high humidity levels.

The subject invention more specifically reveals a coated fabric which is comprised of at least one layer of fabric and at least one layer of thermoplastic polymer, wherein the TBC is comprised of (I) the reaction product of (1) a hydrophobic polyol or polyamine, (2) a polyisocyanate or an aromatic dicarboxylic acid, and (3) a linear chain extender containing 2 to 20 carbon atoms, or (II) the reaction product of (1) a hydrophobic polyol or polyamine, and (2) a carboxyl terminated telechelic polyamide sequence; wherein the hydrophobic polyol or polyamine has a number average molecular weight which is within the range of about 1,000 to about 4,000 Daltons; wherein the TBC has a weight average molecular weight which is within the range of 50,000 to 1,000,000 Daltons; and wherein the TBC has a melting point which is within the range of 80° C. to 250° C. The TBC will typically be comprised of the reaction product of (1) a hydrophobic polyol, (2) a polyisocyanate or an aromatic dicarboxylic acid, and (3) a linear chain extender containing 2 to 20 carbon atoms; wherein the hydrophobic polyol has a number average molecular weight which is within the range of about 1,000 to about 4,000 Daltons; wherein the TBC has a weight average molecular weight which is within the range of 50,000 to 1,000,000 Daltons; and wherein the TBC has a melting point which is within the range of 80° C. to 250° C.

The present invention more specifically discloses printing blanket or sleeve comprising: a base layer; a compressible layer, and a printing surface layer, wherein the compressible layer is comprised of a TBC which is comprised of (I) the reaction product of (1) a hydrophobic polyol or polyamine, (2) a polyisocyanate or an aromatic dicarboxylic acid, and (3) a linear chain extender containing 2 to 20 carbon atoms, or (II) the reaction product of (1) a hydrophobic polyol or polyamine, and (2) a carboxyl terminated telechelic polyamide sequence; wherein the hydrophobic polyol or polyamine has a number average molecular weight which is within the range of about 1,000 to about 4,000; wherein the TBC has a weight average molecular weight which is within the range of 50,000 to 1,000,000 Daltons; and wherein the TBC has a melting point which is within the range of 80° C. to 250° C. The TBC is typically the reaction product of (1) a hydrophobic polyol, (2) a polyisocyanate or an aromatic dicarboxylic acid, and (3) a linear chain extender containing 2 to 20 carbon atoms; wherein the hydrophobic polyol has a number average molecular weight which is within the range of about 1,000 to about 4,000; wherein the TBC has a weight average molecular weight which is within the range of 50,000 to 1,000,000 Daltons; and wherein the TBC has a melting point which is within the range of 80° C. to 250° C.

The subject invention further reveals a cured in place liner for a passageway or pipe comprising: (a) a resin absorbent material layer; (b) a thermoset resin absorbed into said resin absorbent material layer; and (c) a TBC coating layer on at least one side of said resin absorbent material layer; wherein the TBC is comprised of (I) the reaction product of (1) a hydrophobic polyol or polyamine, (2) a polyisocyanate or an aromatic dicarboxylic acid, and (3) a linear chain extender containing 2 to 20 carbon atoms, or (II) the reaction product of (1) a hydrophobic polyol or polyamine, and (2) a carboxyl terminated telechelic polyamide sequence; wherein the hydrophobic polyol or polyamine has a number average molecular weight which is within the range of about 1,000 to about 4,000; wherein the TBC has a weight average molecular weight which is within the range of 50,000 to 1,000,000 Daltons; and wherein the TBC has a melting point which is within the range of 80° C. to 250° C. The TBC is typically comprised of the reaction product of (1) a hydrophobic polyol, (2) polyisocyanate or an aromatic dicarboxylic acid, and (3) a linear chain extender containing 2 to 20 carbon atoms; wherein the hydrophobic polyol has a number average molecular weight which is within the range of about 1,000 to about 4,000 Daltons; wherein the TBC has a weight average molecular weight which is within the range of 50,000 to 1,000,000 Daltons; and wherein the TBC has a melting point which is within the range of 80° C. to 250° C.

The subject invention also discloses a method of making a printing blanket or sleeve including a compressible layer comprising: providing a base substrate web or sleeve; providing a source of TBC in molten form including a void-producing material; extruding said TBC over substantially the entire surface of said base substrate or sleeve to form a compressible layer thereon; and providing a printing surface layer over said compressible layer: wherein the TBC is comprised of (I) the reaction product of (1) a hydrophobic polyol or polyamine, (2) a polyisocyanate or an aromatic dicarboxylic acid, and (3) a linear chain extender containing 2 to 20 carbon atoms, or (II) the reaction product of (1) a hydrophobic polyol or polyamine, and (2) a carboxyl terminated telechelic polyamide sequence; wherein the hydrophobic polyol or polyamine has a number average molecular weight which is within the range of about 1,000 to about 4,000 Daltons; wherein the TBC has a weight average molecular weight which is within the range of 50,000 to 1,000,000 Daltons; and wherein the TBC has a melting point which is within the range of 80° C. to 250° C. The TBC is typically comprised of the reaction product of (1) a hydrophobic polyol, (2) a polyisoeyanate or an aromatic dicarboxylic acid, and (3) a linear chain extender containing 2 to 20 carbon atoms; wherein the hydrophobic polyol has a number average molecular weight which is within the range of about 1,000 to about 4,000 Daltons; wherein the TBC has a weight average molecular weight which is within the range of 50,000 to 1,000,000 Daltons; and wherein the TBC has a melting point which is within the range of 80° C. to 250° C.

### BRIEF DESCRIPTION OF THE DRAWINGS

FIG. 1 is a perspective view of a printing blanket including a TPU compressible layer.

FIG. 2 is a cross-section of a printing sleeve including a TPU base layer, a TPU compressible layer, and a TPU printing surface layer.

### DETAILED DESCRIPTION OF THE INVENTION

The articles of this invention are manufactured utilizing a TBC that can be a polyurethane (TPU), a copolyester (COPE), a copolyamides (COPA), or a polyurethaneurea (TPUU). The thermoplastic polyurethane (TPU) that can be used in the practice of this invention is comprised of the reaction product of (1) a hydrophobic polyol, (2) a polyisocyanate, and (3) a chain extender containing 2 to 20 carbon atoms; wherein the hydrophobic polyol has a number average molecular weight which is within the range of about 1,000 to about 4,000 Daltons; wherein the TPU has a weight average molecular weight which is within the range of 50,000 to 1,000,000 Daltons and a melting point which is within the range of 80° C. to 250° C. The number average molecular weight (Mn) is determined by assay of terminal functional groups.

The COPA polymers that can be used in the practice of this invention can be the reaction product of a dicarboxylic polyamide with a hydrophobic polyol. These block copolymers have repeat units of the structural formula:

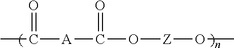

wherein A represents a polyamide sequence and Z represents that part of the polymer derived from a linear or branched hydrophobic polyol. COPA polymers of this type and techniques for their synthesis are described in greater detail in U.S. Pat. No. 4,220,838 and U.S. Pat. No. 4,332,920. The teachings of U.S. Pat. No. 4,220,838 and U.S. Pat. No. 4,332,920 are incorporated herein by reference for the purpose of illustrating COPA polymers that can be used in the practice of this invention and techniques for their synthesis. COPA polymers that are made by reacting a lactam, a polyol, and a polyacyl lactam are described by U.S. Pat. No. 4,223,112. The teachings of U.S. Pat. No. 4,223,112 are incorporated herein by reference for the purpose of illustrating this type of COPA polymer that can be used in the practice of this invention and techniques for its synthesis.

The thermoplastic polyurethaneurea (TPUU) polymers used in the practice of this invention is comprised of the reaction product of (1) a hydrophobic polyamine, (2) a polyisocyanate, and (3) a chain extender containing 2 to 20 carbon atoms; wherein the hydrophobic polyamine has a number average molecular weight which is within the range of about 1,000 to about 4,000 Daltons; wherein the TPUU has a weight average molecular weight which is within the range of 50,000 to 1,000,000 Daltons and a melting point which is within the range of 80° C. to 250° C. The thermoplastic copolyester (COPE) polymers utilized in the practice of this invention is comprised of the reaction product of (1) a hydrophobic polyol, (2) an aromatic diacid, and (3) a chain extender containing 2 to 20 carbon atoms; wherein the hydrophobic polyol has a number average molecular weight which is within the range of about 1,000 to about 4,000 Daltons; wherein the COPE has a weight average molecular weight which is within the range of 50,000 to 1,000,000 Daltons and a melting point which is within the range of 80° C. to 250° C.

The TBC utilized in manufacturing the products of this invention is typically the reaction product of (1) a hydrophobic polyol, (2) polyisocyanate or an aromatic dicarboxylie acid, and (3) a linear chain extender containing 2 to 20 carbon atoms. The technique under which these reactants are polymerized to synthesize the thermoplastic polymer is conducted utilizing conventional equipment, catalysts, and procedures. However, the polymerization is conducted in a manner that will result in attaining a weight average molecular weight which is within the range of about 50,000 to about 500,000 Daltons. It is also, of course, conducted utilizing a hydrophobic polyol and ,a chain extender containing 2 to 20 carbon atoms, except for COPA in which case the hydrophobic polyol is reacted with the carboxyl terminated telechelic polyimide sequence. The chain extender will typically be a linear chain extender that contain from 2 to 12 carbon atoms.

The hydrophobic polyol used in synthesizing the TBCs used in the practice of this invention, such as TPUs, can be a diol of a conjugated diolefin monomer, a poly(isobutylene) diol, a polyester polyol prepared from fatty diols and/or fatty diacids. For instance, diols of conjugated olefin monomers that can be used include hydrogenated poly(butadiene) diols, and hydrogenated poly(isoprene) diols. Hydrogenated poly(butadiene,) polyols are sold by Mitsubishi Chemical Corporation under the trade name POLYTAIL and Kraton polyols sold by Kraton Polymers of Huston, Tex.

Fatty acid polyester polyols containing from about 8 to about 44 carbon atoms are well suited for utilization as the hydrophobic polyol in the practice of this invention. Dimer fatty acids (and esters thereof) are a well known commercially available class of dicarboxylic acids (or esters). They are normally prepared by dimerising unsaturated long chain aliphatic monocarboxylic acids, usually or 13 to 22 carbon atoms, or their esters (alkyl esters). The dimer acid material will usually contain 26 to 44 carbon atoms. Particularly, examples include dimer acids (or esters) derived from C₁₈ and C₂₂ unsaturated monocarboxylic acids (or esters) which will yield, respectively, C₃₆ and C₄₄ dimer acids (or esters). Dimer acids derived from C₁₈ unsaturated acids, which include acids such as linoleic and linolenic are particularly well known (yielding C₃₆ dimer acids). For example, DELTA 9, 11 and DELTA 9, 12 linoleic acids can dimerise to a cyclic unsaturated structure (although this is only one possible structure; other structures, including, acyclic structures are also possible).

The dimer acid products will normally also contain proportions of timer acids (C₅₄ acids when using C₁₈ starting acids), possibly even higher oligomers and also small amounts of the monomer acids. Several different grades of dimer acids are available from commercial sources and these differ from each other primarily in the amount of monobasic and trimer acid fractions and the degree of unsaturation. Priplast™ polyester polyols are branched C₃₆ dimerized fatty acids which are particularly useful as the hydrophobic polyol, in the practice of this invention. Priplast™ polyester polyols are commercially available from Croda Uniqema Inc. of Gouda, The Netherlands. The hydrophobic polyol used in synthesizing the TPU of this invention will typically have a number average molecular weight which is within the range of about 1,500 to about 4,000 Daltons and will preferably have a number average molecular weight which is within the range of about 2,000 to about 3,000 Daltons.

The hydrophobic polyols used in synthesizing TPUU and COPA polymers that can be employed in the practice of this invention are typically straight chained or branched diamines of the structural formula: H₂N—(CₘH₂ₘ)—NH₂, wherein in is an integer that represents the number of carbon atoms in the hydrophobic polyol. These hydrophobic polyols can be a diamine terminated ethylene-propylene copolymer rubber, a diamine terminated hydrogenated diene rubber, such as hydrogenated polyisoprene or hydrogenated polybutadiene, or the like.

The chain extender that can be used in synthesizing the TBC include organic diols or glycols having from 2 to about 20 carbon atoms, such as alkane diols (straight chained and branched), cycloaliphatic diols, alkylaryl diols, and the like. Alkane diols which have a total from about 2 to about 12 carbon atoms are often utilized. Some representative examples of alkane diols that can be used include ethanediol, propane glycol, 1,6-hexanediol, 1,3-butanediol (1,3-BDO), 1,5-pentanediol, neopentylglycol (NPG), 2-butyl-2-ethyl-1,3-propanediol, 2,4-diethyl-1,5-pentanedial, 3-methyl-1,5-pentanediol, and 1,4-butanediol. Dialkylene ether glycols, such as diethylene glycol and dipropylene glycol, can, also be used as the chain extender. Examples of suitable cycloaliphatic diols include 1,2-cyclopentanediol, 1,4-cyclohexanedimethanol (CHDM) and the like. Examples of suitable alkylaryl diols include hydroquinone di(β-hydroxyethyl)ether (HQEE), 1,4-benzenedimethanol, bis(hydroxy ethoxy) biphenol, bisphenol A ethoxylates, bisphenol F ethoxylates and the like. Still, other suitable chain extenders are 1,3-di(2-hydroxyethyl)benzene, and 1,2-di(2-hydroxyethoxy)benzene. Mixtures of the above noted chain extenders can also be utilized.

Chain extenders with a functionality of greater than 2 may also be used with the proviso that the resulting polymer retains its thermoplastic nature and other desired chemical and physical characteristics. Examples of such multitlinctional chain extenders include trimethylolpropane, glycerin, and pentraerythritol. Normally, multifunctional chain extenders are used in conjunction with difunctional chain extenders to limit the degree of resulting chain branching. Accordingly, the level of multifunctional chain extenders typically does not exceed 10 mole percent of the total amount of chain extenders used in making the thermoplastic polymer. In other words, difunctional chain extenders will typically represent at least about 90 mole percent of the total amount of chain extenders used in synthesizing the polymer.

The linear chain extender are typically preferred for used in making the TBC of this invention will typically be of the structural formula:

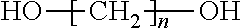

wherein n represents an integer from 2 to 20 and wherein n typically represents an integer from 2 to 12. Accordingly, the linear chain extender will typically be selected from the group consisting of ethylene glycol, 1,3-propane diol, 1,4-butane diol, 1,5-pentane diol, 1,6-hexane diol, 1,7-heptane diol, 1,8-octane diol, 1,9-nonane, diol, 1,10-decane diol, 1,11-undecane diol, and 1,12-dodecane diol. The most preferred chain extender is 1,12-dodecane diol with it being preferred for the chain extender to consist entirely of 1,12-dodecane diol. However, it should be appreciated that various mixtures ofdills can be utilized as the chain extender in the practice of this invention. To attain higher melting points linear chain extenders having lower molecular weights (fewer carbon atoms) will typically be utilized. For instance, ethylene glycol can be used in synthesizing thermoplastic polymers having relatively high melting points. On the other hand, linear chain extenders of higher molecular weights will typically be utilized in making thermoplastic polymers having lower melting points. For instance, 1,12-dodecane diol can be employed in synthesizing thermoplastic polymers having rela tvely low melting points.

The polyisocyanate used in synthesizing the thermoplastic polymer is preferably a diisocyanate. While aliphatic diisocyanates can be utilized, aromatic diisocyanates are highly preferred. Moreover, the use of multifunctional isocyanate compounds, i.e., triisocyanates, etc., which cause crosslinking, are generally avoided and thus the amount used if any, is generally less than 4 mole percent and preferably less than 2 mole percent based upon the total moles of all of the various isocyanates used. Suitable diisocyanates include aromatic diisocyanates such as: 4,4′-methylene bis-(phenyl isocyanate) (MDI); m-xylene diisocyanate (XDI), phenylene-1-4-diisocyanate, naphthalene-1,5-diisocyanate, diphenylmethane-3,3′-dimethoxy-4,4′-diisocyanate, and toluene diisocyanate (TDI): as well as aliphatic diisocyanates such as isophorone diisocyanate (IPDI), 1,4-cyclohexyl diisocyanate (CHDI), decane-1,10-diisocyariate, and dicyclohexylmethane-4,4′-diisocyanate. Dimers and trimers of the above diisocyanates may also be used as well as a blend of two or more diisocyanates may be used.

The polyisocyanate used in this invention may be in the form of a low molecular weight polymer or oligomer which is end capped with an isocyanate. For example, the hydroxyl terminated hydrophobic polyol described above may be reacted with an isocyanate-containing compound to create a low molecular weight polymer end capped with isocyanate. In the TPU art, such materials are normally referred to as pre-polymers. Such pre-polymers normally have a number average molecular weight (Mn) which is within the range of about 500 to about 10,000 Daltons.

The mole ratio of the one or more diisocyanates is generally from about 0.95 to about 1.05, and preferably from about 0.98 to, about 1.03 moles per mole of the total moles of the one or more hydrophobic polyols and the one or more chain extenders. The molar ratio of the chain extender to the polyol will typically be within the range of about 0.3:1 to 5:1 and will more typically be within the range of about 0.4:1 to 4:1. The molar ratio of the chain extender to the polyol will preferably be within the range of about 0.5:1 to 3:1 and will more preferably be within the range of about 0.5:1 to 2:1.

A wide variety of aromatic dicarboxylic acids can be utilized in synthesizing the TBCs used in accordance with this invention. The aromatic dicarboxylic acid will typically contain from 8 to 16 carbon atoms. Some representative examples of aromatic dicarboxylic acids that can be used include terephthalic acid, isophthalic acid, orthophthalic acid, 1,8-naphthalenediearboxylic acid, 1,7-naphthalenedicarboxylic acid, 1,6-naphthalenedicarboxylic acid, 1,5-naphthalenedicarboxylic acid, 2,6-naphthalenediearboxylic acid, 2,7-naphthalenedicarboxylic acid, 1,7-anthracenediearboxylic acid, 2,6-anthracenedicarboxylic acid, 2,7-anthracenedicarboxylic acid, 2,6-phenalenedicarboxic acid, ,6-phenalenedicarboxylic acid, 1,7-phenalenedicarboxylic acid, 2,8-naphthacenedicarboxylic acid, 2,9-naphthacenedicarboxylic acid, 1,7-naphthacenedicarboxylic acid, 1,10-naphthacenedicarboxylic acid, 2,7-pyrenedicarboxylic acid, 2,6-pyrenedicarboxylic acid, and 2,8-pyrenedicarboxylic acid. The preferred aromatic dicarboxylic acids include terephthalic acid, isophthalie acid, and 2,6-naphthalenedicarboxylic acid with terephthalic acid typically being the most preferred.

The TBC used in manufacturing the products of this invention can be a polyurethane, a copolyester, a copolyamide or a polyurethaneurea. However, TPUs are typically used as the TBC. TBCs, such as TPUs, that are useful in making the articles of this invention can be synthesized utilizing the same techniques and equipment as are used in making conventional TPUs. For instance, in synthesizing TPUs that are suitable for use in the practice of this invention, the hydrophobic polyol, the diisocyanate, and the chain extender are generally added together and reacted in accordance with any conventional urethane reaction method. Preferably, the TPU forming components of the present invention are melt polymerized in a suitable mixer, such as an internal mixer (a Banbury mixer), or preferably an extruder. In the preferred process, the hydrophobic polyol is blended with the glycol chain extender and added to the extruder as a blend. The diisocyanate is added separately to the extruder. Suitable processing or polymerization starting temperatures of the diisocyanate is from about 100° C. to about 200° C., and preferably from about 100° C. to about 150° C. Suitable processing or polymerization starting temperatures of the blend of the hydrophobic polyol and the aromatic chain extender is from about 100° C. to about 220° C., and preferably from about 150° C. to 200° C. Suitable mixing times in order to enable the various components to react and form the TPU polymers of the present invention are generally from about 2 to about 10 minutes, and preferably from about 3 to about 5 minutes.

The preferred process to produce the TPU is the process referred to as the one-shot polymerization process. In the one-shot polymerization process which generally occurs in situ, a simultaneous reaction occurs between three components, that is the one or more hydrophobic polyol, the chain extender, and the diisocyanate. The reaction is generally initiated at a temperature of from about 90° C. to about 200° C. In as much as the reaction is exothermic, the reaction temperature generally increases to about 220° C. to 250° C. The TPU polymer will exit the reaction extruder and will typically be pelletized. The pellets of TPU are normally stored in a heated vessel to continue the reaction and to dry the TPU pellets.

It is often desirable to utilize catalysts such as stannous and other metal carboxylates as well as tertiary amines. Examples of metal carboxylates catalysts include stannous oetoate, dibutyl tin dilaurate, phenyl mercuric propionate, lead octoate, iron acetylacetonate, magnesium acetylacetonate, and the like. Examples of tertiary amine catalysts include tricthylene diamine, and the like. The amount of the one or more catalysts is low, generally from about 50 to about 100 parts by weight per million parts by weight of the end TPU polymer formed.

The weight average molecular weight (Mw) of the TPU polymer used in the practice of this invention will typically be in the range of about 50,000 to about 500,000 Daltons, preferably from about 100,000 to about 500,000 Daltons, and more preferably from about 120,000 to about 300,000 Daltons. The Mw of the TPU polymer is measured according to gel permeation chromatography (GPC) against polystyrene standard.

When a higher molecular weight TPU polymer is desired, it can be achieved by using a small amount of a cross linking agent having an average functionality greater than 2.0 to induce cross linking. The amount of cross linking agent used is preferably less than 2 mole percent of the total moles of chain extender, and more preferably less than 1 mole percent. A particularly desirable method to increase the molecular weight in the preferred TPU polymer is to replace less than 1 mole percent of the chain extender with trimethylol propane (TMP).

The cross linking is accomplished by adding a cross linking agent having an average functionality greater than 2.0 together with the hydrophobic polyol, the isocyanate compound, and chain extender in the reaction mixture to manufacture the TPU polymer. The amount of cross linking agent used in the reaction mixture to make the TPU polymer will depend on the desired molecular weight and the effectiveness of the particular cross linking agent used. Usually, less than 2.0 mole percent, and preferably less than 1.0 mole percent, based on the total moles of chain extender used in making the TPU polymer are used. Levels of cross linking agent greater than 2.0 mole percent, based on the total moles of chain extender would be difficult to melt process. Therefore, the level of cross linking agent used is from about 0.05 mole percent to about 2.0 mole percent based on the total moles of chain extender.

The cross linking agents can be any monomeric or oligomeric materials which have an average functionality of greater than 2.0 and have the ability to cross link the TPU polymer. Such materials are well known in the art of thermoset polymers. Preferred cross linking agents include trimethylol propane (TMP) and pentaerythritol. Triinethylol propane has been found to particularly be a desirable cross linking agent.

The TPU polymers used in accordance with this invention can be mixed with various conventional additives or compounding agents, such as fillers, antioxidants, extenders, pigments, colorants, lubricants, UV absorbers, plasticizers, processing oils, waxes, and the like. Fillers that can be used include talc, silicates, clays, calcium carbonate, and the like. The level of conventional additives will depend on the final properties and cost of the desired end-use application, as is well known to those skilled in the art of compounding TPUs. The additives may be added during the reaction to form the TPU, but are normally added in a second compounding step.

The TPU polymer used in the practice of this invention has a melting point which is within the range of about 80° C. to about 250° C. It will typically have a melting point which is within the range of about 90° C. to about 180° C., and will more typically have a melting point which is within the range of about 110° C. to about 170° C. The melting point of the TPU polymer can be measured according to ASTM D-3417-99 using a differential scanning calorimeter (DSC). However, in the case of very soft polymers the Kofler method can be used to measure the melting point of the TPU.

The TPUs used in manufacturing the articles of this invention offers excellent resistance against compression set and tensile set. For instance, this TPU typically offers a tensile set at 200% strain of less than 20%, preferably less than 15%, and most preferably less than 10% when tested at 23° C. in accordance with ASTM D412. They also offer high tensile strengths of over 1000 psi (6.9×10⁶ Pascals) and elongations to break of greater than 500% as measured according to ASTM D412 at 23° C. The TPU will also preferable have a tensile strength of greater than 1500 psi (1.0×10⁷ Pascals) and will most preferably exhibit a tensile strength of greater than 2000 psi (1.4×10⁷ Pascals).

### Printing Blankets

One of the most common commercial printing processes is offset lithography. In this printing process, ink is offset from a printing plate to a rubber-surfaced printing blanket or cylindrical sleeve mounted on a blanket cylinder before being transferred to a substrate, such as paper. Typically, the printing blanket or sleeve includes at least one base layer comprised of metal or fabric, and a printing surface layer formed from a polymeric rubber material which is adapted to carry and transfer liquid printing ink. The blanket or sleeve also typically includes an intermediate compressible layer. U.S. Patent Application Publication No. 2008/0070042 A1 discloses a printing blanket or sleeve including thermoplastic polyurethane or thermoplastic polyurethane alloy layers. The teachings of U.S. Patent Application Publication No 2008/0070042 A1 are incorporated herein by reference for the purpose of illustrating printing blankets that can be manufactured utilizing the hydrophobic thermoplastic block copolymers of this invention.

Most printing surface layers currently in use typically comprise natural or synthetic rubber materials which require the use of a solvent to dissolve the rubber material so that it may be coated, in numerous thin passes, onto the base ply. The solvent must then be evaporated prior to curing. Alternatively, the natural or synthetic rubber materials may be calendered onto the base ply in a single pass, but at great expense due to the need to adequately control gauge. In both methods, the rubber must be cured under pressure, which is a time consuming process.

Compressible layers currently in use are typically comprised of materials such as synthetic rubbers, rubber blends, and cast urethane, which have been processed into a cellular, or foam, form containing voids. Again, the use of rubbers typically requires the use of solvents to dissolve the rubber material for processing, which must then be evaporated prior to curing. Cast urethanes can also present complications in processing as their pot life must be carefully controlled, and this can lead to difficulty in mixing, casting and curing.

As the compressible layer allows positive displacement of the printing surface layer without causing distortion of the image, the compressible layer must exhibit good recovery from impact in order to be effective. Generally, the ability of the blanket to resist permanent compression determines its useful life, thus the compressible layer is typically the layer that limits the longevity of the blanket. As such, it would be desirable to form a compressible layer with materials which improve the ability of the compressible layer to resist permanent compression set and subsequently, improve the longevity of the printing blanket.

Accordingly, there is a need in the art for an image transfer product such as a printing blanket or sleeve formed from layers which may be easily processed, which provides the desired gauge and texture for printing, and which exhibits resistance to permanent compression. The present invention meets those needs by providing an offset printing blanket or sleeve including one or more layers which is made with the TBC previously described herein or with an alloy thereof. The use of this TBC provides an advantage over previously used polymeric rubber materials because the TBC is supplied and processed without the need for solvents.

According to one aspect of the present invention, a printing blanket or sleeve is provided comprising at least a base layer, a compressible layer, and a printing surface layer, wherein the compressible layer has voids therein; and wherein the compressible layer is comprised of the TBC. The TBC can optionally be alloyed with a nitrile rubber, EPDM, polysulfide, or butyl rubber.

In one embodiment of the invention, the base layer of the blanket or sleeve may comprise a fabric, a metal, or a polymeric material. In another embodiment, the base layer may comprise a thermoplastic polymer or thermoplastic polymer alloy. The printing surface layer may comprise a rubbery polymeric material. In an alternative embodiment of this invention, the printing surface layer is comprised of the TBC or an alloy of the TBC.

In accordance with another aspect of the invention, a printing blanket or sleeve is provided comprising a base layer comprising the TBC or a alloy thereof, and a printing surface layer comprising a thermoplastic polymer or thermoplastic polymer alloy. The printing blanket or sleeve may further include a compressible layer positioned between the base layer and the printing surface layer, where the compressible layer comprises a thermoplastic polymer or a thermoplastic polymer alloy having voids therein. In this embodiment, the printing surface layer preferably comprises a thermoplastic polymer alloy, and more preferably, a thermoplastic polymer/nitrile alloy.

The printing blanket or sleeve of this embodiment may further include an image reinforcement layer positioned below the printing surface layer. The image reinforcement layer may comprise a fabric, the TBC, or an alloy of the TBC. Preferably, the image reinforcement layer comprises a TBC having a Shore A hardness which is greater than the Shore A hardness of the printing surface layer. Preferably, the image reinforcement layer has a Shore A hardness of between about 55 to 95.

The printing blanket or sleeve of this embodiment may further include one or more reinforcing fabric layers positioned between the base layer and the printing surface layer. Where an image reinforcement layer is included in the construction, the reinforcing fabric layer is preferably positioned below the image reinforcement layer. According to another aspect of the invention, a method of making a printing blanket or sleeve including a compressible layer is provided comprising providing a base substrate web or sleeve; providing a source of the TBC or an alloy thereof in molten form including a void-producing material; extruding the TBC or alloy thereof over substantially the entire surface of the base substrate or sleeve to form a compressible layer thereon; and providing a printing surface layer over the compressible layer.

The void-producing material is selected from the group consisting of pre-expanded microspheres, unexpanded microspheres, and blowing agents. Alternatively, the voids may be created by incorporating a leachable material that is subsequently removed after formation of the layer or by whipping air into the thermoplastic polymer while it is in a liquid state.

In one embodiment of the method, the void-producing material comprises unexpanded microspheres, and the method of extruding the TBC further comprises expanding the microspheres. In an alternative embodiment, the void-producing material comprises unexpanded mierospheres, wherein the microspheres are expanded by heating after extrusion of the compressible layer. In another embodiment of the invention, a method of making a printing blanket or sleeve including a compressible layer is provided comprising providing a base layer comprising a substrate web or sleeve; applying a compressible layer comprising a thermoplastic polymer or thermoplastic polymer alloy to the substrate web or sleeve; and providing a printing surface layer over the compressible layer. In this embodiment, the compressible layer may be in the form of a film or sheet which is laminated to the base layer. The base layer may comprise a fabric, metal, polymer, or a thermoplastic polymer or thermoplastic polymer alloy. The printing surface layer may comprise a rubber, the TBC, or an alloy of the TBC.

In still another embodiment of the invention, the method of making a printing blanket or sleeve comprises providing a base layer comprising a substrate web or sleeve and providing a printing surface layer over the base layer; where the base layer and the printing surface layer comprise the TBC or an alloy of the TBC. Accordingly, it is a feature of embodiments of the present invention to provide a printing blanket or sleeve in which at least one of the base layer, compressible layer, or printing surface layer is formed from a thermoplastic polymer or thermoplastic polymer alloy.

The properties of the TBCs give them a distinct processing advantage for use as layers in a printing blanket or sleeve construction. The use of these TBCs or TBC alloys provides flexibility in designing a printing blanket or sleeve having the desired properties for use in offset printing. Further, the TBCs do not require the use of solvents in processing, which saves time, cost, and effort in adding, drying, and recovering solvents in addition to initial purchase of the solvents. Furthermore, the TBCs dca not cure like traditional rubber materials used in blanket constructions, affbrding additional process time and energy savings. These TBCs also provide an advantage in that they are easily colorable and recyclable. Further, these TBCs maintain their elastomerie behavior over a wide temperature range, and they have a high rebound ability and improved cohesive strength, resulting in longer life for the printing blanket or sleeve in which they are incorporated.

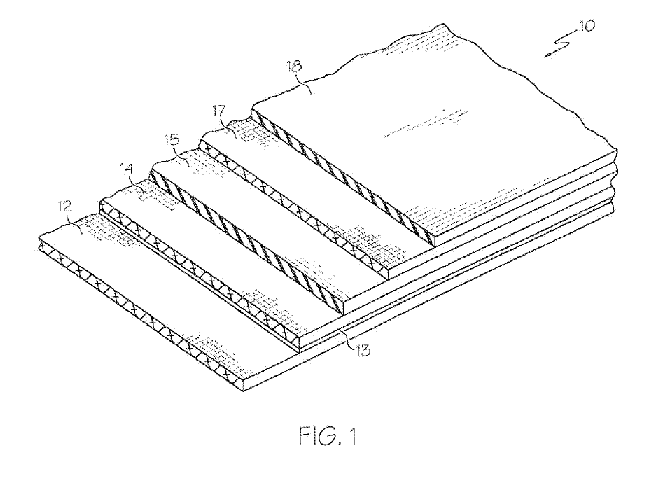

Referring now to FIG. 1, one embodiment of the invention is shown in the form of a printing blanket 10. It will be appreciated that the layers as shown in the blanket construction are also applicable to a sleeve construction. The printing blanket 10 is shown comprising a base layer 12, a compressible layer 15, and a printing surface layer 18. The blanket optionally may include additional layers such as for example, fabric reinforcing ply or layer 14 and image reinforcing ply or layer 17. The various blanket plies or layers may be secured to one another using a suitable adhesive 13. In the embodiment shown, base iayer 12 comprises a fabric layer. It should be appreciated that more than one base layer may be included in the construction. In this embodiment, the printing surface layer 18 comprises a polymeric rubber material, but may alternatively comprise the TBC or an alloy of the TBC.

The base layer may alternatively be comprised of the TBC or an alloy of the TBC winch provides support when the printing blanket is placed under tension. Where the printing blanket is tensioned, the base layer should have a coefficient of friction which facilitates even tensioning of the blanket around a printing cylinder. This may be achieved with the use of the TBC, an alloy of the TBC, the TBC reinforced with fibers, or a composite of the TBC with a textile fabric. Where the printing blanket is non-tensioned, a metal base layer may be used, or any of the above TBC materials may be used as long as they provide the desired low elongation properties.

The compressible layer 15 is comprised of the TBC and/or an alloy of the TBC. The TBC or an alloy of the TBC can be formed into compressible layers by introducing voids within the TBC material. These voids may be induced by using techniques that include the incorporation of pre-expanded microspheres, unexpanded microspheres that expand with the thermal processing of the starting material, or the use of endothermic or exothermic blowing agents. Other suitable techniques include the incorporation and subsequent removal of leachable additives, mechanical whipping of the material, and/or the incorporation of low-boiling liquid additives.

The ability to control void gauge and percentage void content varies, depending on the method in which the voids are introduced. The use of microspheres is preferred for introducing voids into the TBC. Microspheres can be incorporated into the TBC compound prior to TBC pellet formation or as an additive during thermal processing such as extrusion as explained below.

When using pre-expanded microspheres, care must be taken so that the voids are not destroyed by thermal processing that relies on shear, such as extrusion. The use of unexpanded microspheres is preferred for use in the present invention. Such microspheres expand with heat and can be added during extrusion and expanded as the TBC mixture exits an extrusion die as described below or subsequent to extrusion with the application of additional heat. Void gauge is controlled by the proper application of heat, the rate of cooling, and the pressure applied to the layer during layer formation and/or lamination. Percentage void content for either pre-expanded or unexpanded microspheres is a function of void gauge, the number of spheres added, and their uniform distribution within the compressible layer.

The TBC compressible layer is preferably produced using unexpanded microspheres dispersed in, for example, ethylene vinyl acetate, and a thermoplastic polymer having a Shore A hardness of from about 55 to 70. Suitable methods of incorporating microspheres in a TBC are disclosed in European Patent Applications EP 1 174 459 A1 and EP 1 233 037 A2, and PCT applications WO 01/10950, and WO 00/44821, the subject matter of which are incorporated herein by reference.

Where the TBC compressible layer is produced using expanded microspheres, the temperature of the TBC during the application process should be kept below the expansion temperature of the microspheres so that the amount of expansion will remain constant during the processing of the compressible layer. Where the TBC compressible layer is produced using unexpanded microspheres, the TBC may be heated just to or slightly above the expansion temperature of the TBC during extrusion such that the expansion occurs at or near the exit of the extrusion die. The still soft TBC is then passed through a calibrating nip to achieve the desired gauge. Alternatively, the temperature of the TBC may be kept below the expansion temperature of the microspheres during the extrusion process and subsequently brought just to or slightly above the expansion temperature of the microspheres. In this case, the softening point of the TBC should be matched relatively closely to the expansion temperature of the microspheres so that it can deform to accommodate the expansion. One method of raising the temperature of the TBC to the expansion temperature of the microspheres is to pass the extruded TBC film containing the unexpanded microspheres through a heated nip or series of heated nips so that the temperature of the composite is gradually raised to the expansion temperature of the microspheres and expansion occurs under pressure to control the total gauge of the compressible layer. This temperature exceeds the temperature reached during compounding and extrusion, allowing the material to soften and the microspheres to expand under pressure, controlling the amount of expansion. Alternatively, endothermic and/or exothermic blowing agents may be introduced into the TBC material during initial compounding/manufacturing of the TBC and prior to TBC pellet formation or, preferably, during thermal processing. Blowing agents decompose when their activation temperature is reached and release gas upon decomposition. Endothermic blowing agents absorb energy during decomposition and tend to release less gas than exothermic agents, approximately 110 ml/g. Such blowing agents are useful in producing finer and more homogeneous foams.

Exothermic blowing agents emit energy during decomposition and tend to release more gas than endothermic agents, approximately 220 ml/g. They are useful in producing foams with larger void gauge. The void gauge and percentage void content is dependent on the amount and type of blowing agent, heat, the rate of cooling, and the pressure applied to the layer during layer formation and lamination.

Leachable additives such as various salts, sugars, or other selectively soluble materials can also be added to the TBC in the compounding stage or during thermal processing. Once the leachable additives are incorporated, voids will not be induced until the TBC layer is formed. At this point, the TBC layer must be brought into contact with an appropriate solvent that will dissolve or leach out the additives without degrading the layer. With the additives thus removed, voids remain in the layer. The gauge of these voids is determined by the gauge of the particulate additive selected, while the percentage void content is a function of the quantity and distribution of the additive and degree of removal.

Mechanical whipping of the molten TBC can also be employed to introduce voids within the layer. For example, when the TBC has been melted by thermal processing by extrusion or other means, the TBC can be agitated by mechanical means such that air or other gases are incorporated. Such mechanical means can include stirring, beating, whipping, or any other mechanical process in which air or other gases are forcibly mixed into the molten material. Alternatively, air or other gases may be injected into the molten TBC and mixed to disperse the air/gas evenly throughout. The whipped/mixed material can then be formed into an appropriate layer. Void gauge and percentage void content is mechanically controlled by the severity of the whipping/mixing process, the amount of air or gas introduced, and by the geometry of whipping/mixing equipment such as agitators, screws, and paddles.

Low-boiling liquid additives such as fluorocarbons or chlorocarbons can also be incorporated during thermal processing of the TBC. However, selection of the liquid and thermal processing parameters must be done with care so that the liquid is intermixed well within the TBC prior to boiling. When the boiling occurs, voids are formed within the material that will be retained when the TBC material cools during layer formation. The void gauge and percentage void content are determined by the amount and type of liquid added, the balance of heat and cooling, and the pressure applied to the layer during formation and lamination.

While the compressible layer has been described herein as comprising a TBC layer, it should also be appreciated that the compressible layer, in certain blanket/sleeve constructions, may comprise a polymeric rubber layer. Such a compressible polymeric rubber layer may be incorporated with voids as described above. The compressible layer preferably has a thickness of from about 0.006 inches to about 0.100 inches (about 0.15 mm to 2.54 mm), and more preferably, from about 0.010 inches to about 0.060 inches (about 0.25 mm to 1.5 mm).

The base layer is typically about 0.010 inches to about 0.026 inches (about 0.25 mm to 0.66 mm) thick, and the printing surface layer is typically between about 0.010 inches to 0.025 inches (about 0.25 mm to 0.64 mm) thick. However, it should be appreciated that the thickness of the base layer and printing surface layer may vary, depending on the materials selected for the layers and the desired finished blanket/sleeve properties.

In the preferred method of making a printing blanket or sleeve including the thermoplastic polymer compressible layer 15, a base layer 12 is provided on a printing blanket or sleeve, and the thermoplastic polymer compressible layer is either extruded in liquid form as described above or is laminated to the base layer with the use of heat and/or adhesives. The printing surface layer 18 may be applied to the compressible layer 15 by adhesive bonding, heat lamination, or direct extrusion.

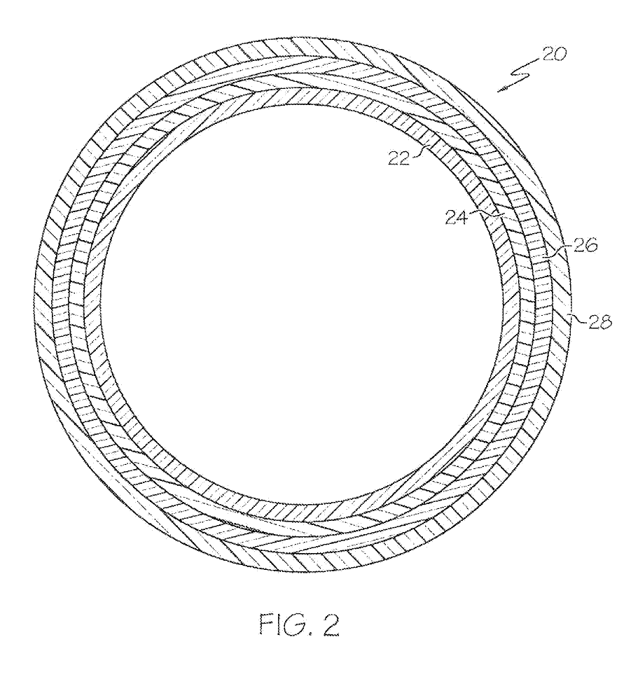

FIG. 2 illustrates another embodiment of the invention in the form of a printing sleeve 20 in which all of the layers in the sleeve have been formed from a thermoplastic polymer or a thermoplastic polymer alloy. It will be appreciated that the layers as shown in the sleeve construction are also applicable to a blanket construction. As shown, the sleeve includes base layer 22, an optional compressible layer 24, an optional image reinforcement layer 26, and a printing surface layer 28.

The base layer 22 is comprised of a low elongation, high tensile strength TBC and/or TBC alloy as described above. The optional image reinforcement layer 26 is positioned beneath the printing surface layer 28 and preferably comprises a hard TBC and/or TBC alloy, which functions to stabilize the printing surface layer 28 and protect the underlying compressible layer 24, when present. The thickness, hardness and elongation of the image reinforcement layer may be modified as desired by the selection of the TBC materials to provide a means of adjusting and varying the feed rate of the product as needed for the particular printing press design. This provides an improvement over textile materials which have previously been used as image reinforcement layers.

The image reinforcement layer preferably has a Shore A hardness ranging from 70 to 95, and more preferably, from about 80 to 90. The TBC material is preferably blended with other polymers or other suitable processing aids to reduce tack and aid in processing.

In the embodiment shown in FIG. 2, printing surface layer 28 comprises a relatively soft and non-plasticized TBC and/or TBC alloy. Suitable TBC alloys include nitrile rubber, isobutylene-isoprene, polysulfide rubber, EPDM terpolymer, natural, rubber, and styrene butadiene rubber. The alloys may further include fillers andlor surface treatments.

The printing surface layer preferably comprises a TBC/nitrile rubber alloy and a mineral additive such as tale. The talc is preferably included at a loading of between about 1% and 35% and functions as an aid during the mechanical surface finishing (grinding) process, i.e., it functions to reduce frictional heat build-up during grinding.

The printing surface layer preferably exhibits a Shore resilience of less than 40%, and an average surface roughness of less than about 0.5 microns. By “Shore resilience,” it is meant the vertical rebound of the layer is measured pursuant to ASTM 2632.

The desired characteristics of the printing surface profile can be provided by thermal forming either before or after applying the TBC or TBC alloy material onto the blanket/sleeve composite. Alternatively, the desired surface profile can be nechanically imparted by abrasion/grinding, or chemically etching or leaching after application of the TBC material to the blanket/sleeve composite.

In embodiments where each of the base layer, optional compressible layer, optional image reinforcement layer, and printing surface layer are comprised of TBC or TBC alloys, such layers may be provided in the form of free or supported films. The layers may be adhered to adjacent layer(s) of the blanket construction by bonding methods well known in the art, or by heat lamination or direct extrusion onto the blanket construction. The layers may also be extrusion-laminated or slot-die coated to adjacent layers, or may be co-extruded with adjacent layers. It should be appreciated that the layers may also be adhered with the use of conventional adhesives. Alternatively, the TBC materials comprising the layers may he softened by the application of heat such that they function as adhesives.

In the practice of this invention, fabric layers may be incorporated into the construction as long as the blanket or sleeve edges are sealed andlor the fabric is sufficiently impregnated with a suitable TBC material to prevent wicking of solvents/chemicals. Where the printing blanket or sleeve layers are comprised primarily of TBC or TBC alloys, edge sealing is readily achieved by heating the exposed edges of the blanket, allowing the thermoplastic material to soften and flow together. Alternatively, additional TBC or TBC alloy may be added with heat to the exposed edges. The added TBC or TBC alloy will bond readily to the blanket cross-section due to its thermoplastic nature.

Where one or more fabric layers are used as a reinforcing layer (for example, as shown in FIG. 1), the preferred fabric exhibits an elongation of about 4 to 16% and a minimum tensile strength of 60 pounds per inch (27.21 kg per cm). The edges of the fabric layers may be sealed with a TPU material or impregnated with TBC or a TBC alloy as described above such that the desired properties are maintained and the fabric no longer retains significant wicking properties.

In embodiments where the blanket or sleeve includes a compressible layer comprised of a TBC or TBC alloy foam, the blanket or sleeve should preferably exhibit a static compressibility of about 0.14 to 0.22 min at 1060 kPA, or about 021 to 0.29 mm at 2060 kPa. The blanket or sleeve including the compressible layer should also exhibit a dynamic gauge loss of less than about 0.025 mm. The blanket or sleeve should also exhibit solvent/swelling resistance. Preferably, in distilled water, the blanket or sleeve should exhibit a volume swell of less than 2.5%; in 3.125% fountain solution, less than 3.0%; in 10% fountain solution, less than 3.5%; and in blanket wash, less than 2.0%.

### Cured in Place Liner

The “cure in place” method of lining damaged or broken pipes, such as sewers, water pipes, and gas pipes, come into wide spread commercial use for repairing underground pipes. This method avoids the need to excavate the underground pipe and the resulting damage to surface infrastructure, such as paved streets and buildings. The cured in place method involves first positioning the liner inside the pipe while the liner is in a flexible state. Then the liner is cured into a hard state within the pipe while being forced against the inside wall of the damaged pipe. This method typically utilizes pressurized an or water to force the flexible liner to conform to the inner surface of the pipe until it is cured into a hard state.

Such pipe liners typically have fabric on one side and a polymer sheet on the other side. The fabric is saturated with an uncured thermoset material. The curing, that is the process of converting the thermoset material to a rigid state, is performed after the liner has been placed inside the pipe. The liner can be placed in the pipe to be repaired by either the “dragged-in” method as described in U.S. Pat. No. 4,009,063 or the “inversion” method as described in U.S. Pat. No. 4,064,211. The teachings of U.S. Pat. No. 4,009,063 are incorporated herein by reference for the purpose of teaching the dragged-in method and the teachings of U.S. Pat. No. 4,064,211 are incorporated herein by reference for the purpose of teaching the inversion method. In any case, the polymer sheet placed on the fabric must be resistant to the (uncured) thermoset material and should also be able to withstand the heat used in curing the thermoset material.

The pipe liners of this invention have a layer of resin absorbent material, such as non-woven fabric, which is capable of accepting a thermoset resin, such as an epoxy resin. The liners of this invention also have a layer of the TBC attached to one surface of the layer of resin absorbent material. The TBC has sufficient heat resistance to be able to withstand the epoxy resin/amine curative exotherm as well as the steam temperature used in installation of the liner. The TBC can also withstand the high temperature without fonning holes in the liner which is referred to in the art as “blow through”. The TBC can also withstand hot water in cases where it is used in the installation of the liner.

A resin absorbent material is used as one layer of the liner. The resin absorbent material can be any material which absorbs the thermoset resin. The resin absorbent layer can be from 0.1 cm to 20 cm thick, preferably 0.2 cm to 15 cm thick, and most preferably 0.3 to 10 cm thick. Suitable resin absorbent materials include fibrous materials of organic or inorganic fiber which may be woven or non-woven fibers. Preferably, the resin absorbent material is a needle punched non-woven material, such as polyester non-woven mat when lining sewers (main or lateral). For lining gas pipes, a glass fiber material is typically preferred.

The TBC is coated onto one side of the resin absorbent material. Melt processing equipment is used to coat the TBC onto the resin absorbent material. Suitable melt processing equipment includes calendar and extrusion processes. The preferred thickness of the TBC coating layer on the liner is from about 100 to about 1000 microns, preferably from about 200 to about 800 microns, and more preferably from about 300 microns to about 500 microns. The TBC coating layer bonds very well to the polyester non-woven mat, thus the polyester non-woven mat is preferred for utilization in the practice of this invention.

In making the liner of this invention, the TBC is melt coated or extrusion coated onto the resin absorbent material. A resin capable of being made into a thermoset resin, such as vinyl ester resin, polyester resin, or epoxy resin is added to the resin absorbent material. If any epoxy resin is used, an amine curing agent is added to the epoxy resin to cure it into a thermoset material. At this stage (before curing), the liner is flexible and can be placed inside the cavity of a passageway or pipe. The flexible liner can be inserted by either the drag-in method or the inversion method. Once inside the cavity, heat is added by injecting steam, hot water, or the like, to force the liner against the inside of the pipe and to cure the thermoset resin in place within the cavity. Once the resin is cured, it becomes a thermoset and the liner becomes rigid to form a rigid inner pipe within the cavity (the original pipe being repaired).

The liner can be made to the desired length required to repair the pipe, and preferably is a continuous tubular liner. The liner should have a length sufficient to repair the pipe with one continuous length that is not required to be spliced together from shorter pieces. The liner will typically be at least 50 meters in length and can be as long as 5000 meters in length. More typically the liners are from 200 meters to 1000 meters in length. The diameter of the liner, once formed into a closed tube will vary depending on the diameter of the pipe needing repair. Typical diameters range from about 5 cm to about 250 cm and are more typically within the range of about 20 cm to about 150 cm.

The liner can conform to the shape of the inside of the pipe needing repair. The shape of the pipe does not need to be perfectly circular and can be non-circular, such as egg-shaped or elliptical in shape. The liner can also negotiate bends in the pipe.

After the resin absorbent fabric is impregnated with thermosetting resin and the liner is made, it is typically stored at a cold temperature, either in an ice bath or a refrigerated truck. This cold storage is necessary to prevent premature curing of the thermoset resin, before it is installed within the pipe being repaired. The liner can be brought to the job site in the refrigerated truck to prevent premature curing of the resin. In some instances, such as with epoxy resin, the resin absorbent layer can be impregnated with the resin at the job site.

After the liner is inserted into the damaged pipe, the resin is cured by exposing the liner to an elevated temperature which is typically within the range of about 80° C. to about 100° C. for a period of about 3 to about 12 hours. Steam curing requires less time, usually about 3 to 5 hours as compared to hot water curing which usually takes about 8 to 12 hours. Thus, there is a tremendous time savings provided by using a TBC that can withstand the high temperatures experienced in the steam curing process.

This invention is illustrated by the following examples that are merely for the purpose of illustration and are not to be regarded as limiting the scope of the invention or the manner in which it can be practiced. Unless specifically indicated otherwise, parts and percentages are given by weight.

### EXAMPLES 1-4

In this experiment a series of TPU polymers were synthesized using the same general procedure with different chain extenders. The procedure used involved heating a blend of hydrophobic polyol and chain extender, and diisocyanate separately to about 120° C. and then mixing the ingredients. The viscosity of the reaction mixture was observed to significantly increase in about 0.5 to 3 minutes at during which time the reaction vessel was emptied and the polymerizate was allowed to slowly cool to room temperature. The chain extender employed and the molar ratio of chain extender to polyol used are reported in Table 1. It should be noted that 1,4-butanediol was used as the chain extender in Example 1. In Examples 2-4 the chain extender was 1,12-dodecanediol. Stannous octoate was used as a catalyst at a level of 50 ppm in each of these examples.

TABLE 1

| Example | 1 | 2 | 3 | 4 |
|---|---|---|---|---|
| Priplast ™ 3196 polyester | 174.00 | 174.00 | 174.00 | 174.00 |
| polyol (Mₐ 3000) | | | | |
| 1,4-BDO | 9.15 | — | — | — |
| 1,12-dodecanediol | — | 5.50 | 14.00 | 20.00 |
| MDI | 39.98 | 21.23 | 31.72 | 39.12 |
| % Urethane Segment | 22.02 | 13.3 | 20.8 | 25.4 |
| Chain Extender to Polyol | 1.75 | 0.469 | 1.195 | 1.707 |
| Molar Ratio | | | | |
| Melt Index (210° C./3800 g)* | 20 | | | |
| Melt Index (190° C./8700 g)* | | 96 | 84 | 70 |
| Melting Temperature (DSC)** | 193° C. | 98° C. | 134° C. | 135° C. |
| Glass Transition Temperature | −45° C. | −43° C. | −43° C. | −45° C. |
| (DSC)** | | | | |
| Crystallization Temperature | 81° C. | | 56° C. | 65° C. |
| (DSC)** | | | | |
| Tensile Strength (psi) | 1170 | 1390 | 2220 | 2070 |
| (ASTM D412) | | | | |
| Tensile Elongation | 452 | 1070 | 724 | 692 |
| (% ASTM D412) | | | | |

*Melt Index values are reported in g/10 minutes
**Second Heat, heat and cooling rates of 10° C./min were used

As can be seen from Table 1, the TPU samples made in Examples 2-4 using 1,12-dodecane diol as the chain extender had superior tensile strength as compared to the TPUs made in Example 1. It should be further noted that the TPUs made in Examples 2-4 also had tensile elongations that were superior to those made in Example 1. The inciting points of the polymers made in Examples 2-4 were all within the range of 98° C. to 135° C. This is in contrast to the TPU made in Example 1 which had a melting point of 193°.

### EXAMPLES 5-10

This series of experiments was conducted using the same general procedure as was employed in Examples 1-4. However, Priplast™ 1838 polyester polyol having a number average molecular weight of about 2000 Daltons was used in this series of experiments (Pripiast™ 3196 polyester polyol has a number average molecular weight of about 3000 Daltons). A blend temperature of 120° C., a MDI temperature of 120° C., a reaction time target of 3 minutes, and a 10 ppm level of stannous octoate catalyst was used in this series of experiments. The chain extender employed and the ratio of chain extender to polyol used are reported in Table 2.

TABLE 2

| Example | 5 | 6 | 7 | 8 | 9 | 10 |
|---|---|---|---|---|---|---|
| Priplast ™ 1838 polyester polyol | 158.00 | 158.00 | 158.00 | 157.00 | 157.00 | 158.00 |
| 1,3-BDO | 8.00 | 12.00 | 1600 | — | — | — |
| 1,6-HDO | 34.00 | 30.00 | 26.00 | 34.00 | 29.00 | 24.00 |
| Neopentylglycol (NPG) | — | — | — | 9.00 | 14.00 | 18.00 |
| MDI | 112.48 | 115.08 | 117.68 | 111.77 | 113.18 | 112.34 |
| % Urethane Segment | 49.43 | 49.85 | 50.26 | 49.64 | 49.86 | 49.41 |
| Chain Extender to Polyol Molar | 4.77 | 4.91 | 5.04 | 4.77 | 4.85 | 4.77 |
| Ratio | | | | | | |
| OA Melt Index (190° C./8700 g)* | 38 | 32 | 40 | 50 | 45 | 40 |
| Melting Temperature (DSC)** | 123° C. | 99° C. | 142° C. | 96° C. | 99° C. | 97° C. |
| Glass Transition Temperature | −45° C. | −44° C. | −46° C. | −43° C. | −44° C. | −43° C. |
| (DSC)** | | | | | | |
| Crystallization Temperature | 96° C. | 119° C. | 97° C. | 107° C. | 98° C. | 101° C. |

*MI values are reported in g/10 minutes.
**Second Heat, heat and cooling rates of 10° C./min were used

While certain representative embodiments and details have been shown for the purpose of illustrating the subject invention, it will be apparent to those skilled in this art that various changes and modifications can be made therein without departing from the scope of the subject invention.

What is claimed is:

1. A coated fabric which is comprised of at least one layer of fabric and at least one layer of TBC, wherein the TBC is comprised of (I) the reaction product of (1) a hydrophobic polyol or polyamine, (2) a polyisocyanate or an aromatic dicarboxylic acid, and (3) a linear chain extender containing 2 to 20 carbon atoms, or (II) the reaction product of (1) a hydrophobic polyol or polyamine, and (2) a carboxyl terminated telechelic polyamide sequence; wherein the hydrophobic polyol or polyamine has a number average molecular weight which is within the range of about 1,000 to about 4,000 Daltons; wherein the TBC has a weight average molecular weight which is within the range of 50,000 to 1,000,000 Daltons; and wherein the TBC has a melting point which is within the range of 80° C. to 250° C.

2. The coated fabric as specified in claim 1 wherein the TBC is comprised of the reaction product of (1) a hydrophobic polyol, (2) a polyisocyanate or an aromatic dicarboxylic acid, and (3) a linear chain extender containing 2 to 20 carbon atoms, and wherein the fabric is comprised of a polymer selected from the group consisting of nylons, polyesters, and polyofefins.

3. The coated fabric as specified in claim 1 wherein the coating comprises an alloy of the TBC with a material selected from the group consisting of nitrile rubber, EPDM rubber, isoprene rubber, styrene-butadiene rubber, butadiene rubber, chloroprene rubber, a styrene-isoprene-styrene triblock polymer, a styrene-butadiene-styrene triblock polymer, a styrene-isoprene diblock polymer, a styrene-butadiene diblock polymer and butyl rubber.

4. The coated fabric as specified in claim 1 which is further comprised of an additional layer which is comprised of a copolyester, an ethyl-vinyl alcohol, a nitrile rubber, an ethylene-propylene-diene rubber, a butyl rubber, a polychloroprene rubber, styrene-butadiene rubber, polyisoprene rubber, polybutadiene rubber, a styrene-isoprene-styrene triblock polyiner, a styrene-butadienc-styrene triblock polymer, a styrene-isoprene diblock polymer, a styrene-butadiene diblock polymer, and a second thermoplastic polymer.

5. A printing blanket comprising: a base layer; a compressible layer, and a printing surface layer, wherein the compressible layer and/or the printing surface layer is comprised of the TBC, wherein the TBC is comprised of (1) the reaction product of (1) a hydrophobic polyol or polyamine, (2) a polyisocyanate or an aromatic dicarboxylic acid, and (3) a linear chain extender containing 2 to 20 carbon atoms, or (II) the reaction product of (1) a hydrophobic polyol or polyamine, and (2) a carboxyl terminated telechelic polyamide sequence; wherein the hydrophobic polyol or polyamine has a number average molecular weight which is within the range of about 1,000 to about 4,000 Daltons; wherein the TBC has a weight average molecular weight which is within the range of 50,000 to 1,000,000 Daltons; and wherein the TBC has a melting point which is within the range of 80° C. to 250° C.

6. The printing blanket as specified in claim 4 wherein said compressible layer comprises an alloy of the TBC with a material selected from the group consisting of nitrile rubber, EPDM rubber, isoprene rubber, styrene-butadiene rubber, butadiene rubber, chloroprene rubber, a styrene-isoprene-styrene triblock polymer, a styrene-butadiene-styrene triblock polymer, a styrene-isoprene diblock polymer, a styrene-butadiene diblock polymer and butyl rubber.

7. The printing blanket as specified in claim 4 wherein the printing surface layer is comprised of the TBC

8. The printing blanket as specified in claim 4 wherein the base layer is comprised of a material selected from the group consisting of fabrics, metals, and polymeric materials.

9. The printing blanket as specified in claim 4 wherein the surface layer is comprised of a rubber.

10. The printing blanket as specified in claim 4 wherein the compressible layer s positioned between said base layer and said printing surface layer.

11. The printing blanket as specified in claim 4 wherein the printing blanket is further comprised of an image reinforcement layer which is positioned below the printing surface layer.

12. The printing blanket as specified in claim 10 wherein the image reinforcement layer is comprised of the thermoplastic block copolymer and a fabric.

13. The printing blanket as specified in claim 11 wherein the image reinforcement layer has a Shore A hardness which is greater than the Shore A hardness of the printing surface layer.

14. The printing blanket as specified in claim 11 wherein the image reinforcement layer has a Shore A hardness which is within the range of about 55 to about 95.

15. The printing blanket as specified in claim 4 which further comprises a reinforcing fabric layer which is positioned below said printing surface layer.

16. The printing blanket as specified in claim 4 wherein the polyisocyanate is an aromatic diisocyanate.

17. The printing blanket as specified in claim 15 wherein the aromatic diisocyanate is selected from the group consisting of 4,4′-methylene bis-(phenyl isocyanate), m-xylene diisocyanate, phenylene-1-4-diisocyanate, naphthalene-1,5-diisocyanate, diphenyhnethane-3,3′-dimethoxy-4,4′-diisocyanate, and toluene diisocyanate.

18. The printing blanket as specified in claim 4 wherein the hydrophobic polyol has a number average molecular weight which is within the range of about 2,000 to about 3,000 Daltons.

19. A cured in place liner for a passageway or pipe comprising: (a) a resin absorbent material layer; (b) a thermoset resin absorbed into said resin absorbent material layer; and (c) a TBC coating layer on at least one side of said resin absorbent material layer; wherein the TBC is comprised of (I) the reaction product of (1) a hydrophobic polyol or polyamine, (2) a polyisocyanate or an aromatic dicarboxylic acid, and (3) a linear chain extender containing 2 to 20 carbon atoms, or (II) the reaction product of (1) a hydrophobic polyol or polyamine, and (2) a carboxyl terminated telechelic polyamide sequence; wherein the hydrophobic polyol or polyamine has a number average molecular weight which is within the range of about 1,000 to about 4,000 Daltons; wherein the TBC has a weight average molecular weight which is within the range of 50,000 to 1,000,000 Daltons; and wherein the TBC has a melting point which is within the range of 80° C. to 250° C.

20. A cured in place liner for a passageway or pipe as specified in claim 19 wherein the resin absorbent material is a needle punched non-woven fabric.

21. A cured in place liner for a passageway or pipe as specified in claim 20 wherein the needle punched non-woven fabric is a polyester fabric.

22. The cured in place liner as specified in claim 19 wherein said coating layer comprises an alloy of the TBC with a material selected from the group consisting of nitrile rubber, EPDM rubber, isoprene rubber, styrene-butadiene rubber, butadiene rubber, chloroprene rubber, a styrene-isoprene-styrene triblock polymer, a styrene-butadiene-styrene triblock polymer, a styrene-isoprene diblock polymer, a styrene-butadiene diblock polymer and butyl rubber.

23. A cured in place liner for a passageway or pipe as specified in claim 19 vherein the polyisocyanate is an aromatic diisocyanate.

24. A cured in place liner for a passageway or pipe as specified in claim 23 wherein the aromatic diisocyanate is selected from the group consisting of 4,4′-methylene bis-(phenyl isocyanate), m-xylene diisocyanate, phenylene-1-4-diisocyanate, naphthalene-1,5-diisocyanate, diphenylmethane-3,3′-dimethoxy-4,4′-diisocyanate, and toluene diisocyanate.

25. A cured in place liner for a passageway or pipe as specified in claim 22 wherein the hydrophobic polyol has a number average rnolccular weight which is within the range of about 2,000 to about 3,000 Daltons.

26. A method of making a printing blanket or sleeve including a compressible layer comprising: providing a base substrate web or sleeve; providing a source of TBC in molten form including a void-producing material; extruding said TBC over substantially the entire surface of said base substrate or sleeve to form a compressible layer thereon; and providing a printing surface layer over said compressible layer: wherein the TBC is comprised of (I) the reaction product of (1) a hydrophobic polyol or polyamine, (2) a polyisocyanate or an aromatic dicarboxylic acid, and (3) a linear chain extender containing 2 to 20 carbon atoms, or (II ) the reaction product of (1) a hydrophobic polyol or polyamine, and (2) a carboxyl terminated telechelic polyamide sequence; wherein the hydrophobic polyol or polyamine has a number average molecular weight which is within the range of about 1,000 to about 4,000 Daltons; wherein the TBC has a weight average molecular weight which is within the range of 50,000 to 1,000,000 Daltons; and wherein the TBC has a melting point which is within the range of 80° C. to 250° C.

27. The method of making a printing blanket or sleeve as specified in claim 26 wherein said void-producing material is selected from the group consisting of pre-expanded microspheres, unexpanded microspheres, blowing agents, and leachable additives.

28. The method of claim 26 wherein said void-producing material comprises unexpanded microspheres and wherein extruding said thermoplastic polymer further comprises expanding said microspheres.

29. The method of claim 26 wherein said void-producing material comprises unexpanded microspheres and wherein said microspheres are expanded by heating after extrusion of said compressible layer.
